(19) United States
(12) Patent Application Publication
(10) Pub. No.: US 2015/0151318 A1
(43) Pub. Date: Jun. 4, 2015

(54) FITMENT FOR FLEXIBLE POUCH

(71) Applicant: Pouch Pac Innovations, LLC, Sarasota, FL (US)

(72) Inventor: R. Charles Murray, Sarasota, FL (US)

(21) Appl. No.: 14/615,611

(22) Filed: Feb. 6, 2015

Related U.S. Application Data
(63) Continuation of application No. 14/202,866, filed on Mar. 10, 2014.
(60) Provisional application No. 61/775,055, filed on Mar. 8, 2013.

(51) Int. Cl. B05B 11/00

(52) U.S. Cl. CPC B05B 11/3033; B05B 11/3045

(57) ABSTRACT

A flexible pouch assembly and fitment is disclosed for dispensing a fluid operable to be securely closed after use. The assembly includes a flexible pouch having an opening at the top of the pouch. A fitment is connected to the opening of the flexible pouch. The fitment includes a canoe portion which connects to the opening of the flexible pouch by means of a connector. The connector may be fixed to the pump or separate from the pump. The canoe portion is also directly connected and fluidly connected to a metering pump. The canoe portion is molded over a tube portion of the metering pump. The canoe portion is sealed to the opening of the flexible pouch. The fitment further includes a cap connected to the canoe portion. The cap includes an outlet fluidly connected to the metering pump. The cap includes a resealable configuration, such as a lid, allowing the user to reseal the pouch after use. The canoe and pump are a once piece configuration.

### CROSS-REFERENCE TO RELATED APPLICATIONS

This application is a continuation in part of U.S. application Ser. No. 14/202,866 filed on Mar. 10, 2014 the contents of which are incorporated herein by reference.

### FIELD OF THE INVENTION

The present invention relates generally to fitments. More particularly, the invention relates to a fitment for a flexible pouch having a metering pump and spout fitment in a one piece configuration with a canoe.

### BACKGROUND OF THE INVENTION

It is known to produce pouches with metering dispensing systems and pumps such as shown in U.S. Pat. No. 8,061,655. The system of previously known embodiments has a pump with a semicircular dome extending over a cavity. The cavity has a one-way valve which permits fluid to be drawn into the cavity and expelled through an outlet. The contents of a package are accessed by removing an end portion from the outlet and pushing the dome portion to pump fluid from inside the pouch into a cavity and out the outlet. However, there is no way of closing or resealing the outlet once opened. Accordingly, it would be desirable to provide a dispensing system for a pouch dispensing fluid such as creams, hand sanitizer, lotion, etc. which may be securely closed after use.

### SUMMARY OF THE INVENTION

The present invention provides for a flexible pouch assembly for dispensing a liquid, cream, lotion, etc. which may be securely closed after use. The assembly includes a flexible pouch having an opening towards the top of the pouch. A fitment is connected to the opening of the flexible pouch. The fitment includes a canoe portion which connects directly to the opening of the flexible pouch. The canoe portion is also directly connected and fluidly connected to a metering pump. The canoe portion is molded over a tube portion of the metering pump. The canoe portion is sealed to the opening of the flexible pouch. The fitment further includes a cap connected to the canoe portion. The cap includes an outlet fluidly connected to the metering pump. The cap includes a resealable configuration, such as a lid, allowing the user to reseal the pouch after use.

A fitment for sealing a flexible pouch is provided including a canoe portion, the canoe portion connected to a metering pump, the canoe portion molded over a tube portion of the metering pump, the canoe portion sealed to the flexible pouch. A cap is provided connected to the canoe portion, the cap having an outlet, the cap in fluid communication with the metering pump, the cap having a resealable configuration. The canoe portion may include a plurality of ridges operable to melt during sealing of the pouch. These ridges may be arranged in many fashions including, but not limited to wherein the ridges are horizontally extending. The ridges are spaced apart on opposed lateral surfaces. The cap is resealable by means of a lid connected to the cap by means of a living hinge.

A flexible pouch assembly for dispensing a liquid having a flexible pouch, the flexible pouch having an upper opening. A fitment connected to the opening of the flexible pouch, the fitment having a canoe portion, the canoe portion connected to a metering pump, the canoe portion molded over a tube portion of the metering pump, the canoe portion sealed to the flexible pouch. A cap connected to the canoe portion, the cap having an outlet, the cap in fluid communication with the metering pump, the cap having a resealable configuration. The canoe portion includes a plurality of ridges operable to melt during sealing of the pouch. The ridges are horizontally extending. The ridges are spaced apart on opposed lateral surfaces. The cap is resealable by means of a lid connected to the cap by means of a living hinge. The flexible pouch may include an indicator operable to instruct the user how to operate the flexible pouch.

### BRIEF DESCRIPTION OF THE DRAWINGS

FIG. 1 is a perspective view of a first embodiment of the pump on the exterior of the pouch of the present invention;

FIG. 2 is a side view of the first embodiment as shown in FIG. 1;

FIG. 3 is a cross-sectional side view of the embodiment as shown in FIG. 1;

FIG. 4 is a secondary embodiment of the resealable cap to be connected to a flexible pouch;

FIG. 5 is a second embodiment of the pouch assembly of the present invention;

FIG. 6 is a front view of a third embodiment where the pump assembly is contained within the flexible pouch;

FIG. 7 illustrates a side view of the third embodiment as illustrated in FIG. 6;

FIG. 8 is a perspective view of the fitment assembly as shown in FIG. 6;

FIG. 9 is an alternative embodiment for a resealable cap;

FIG. 10 is a front view of a tear-off assembly for a fitment for a flexible pouch;

FIG. 11 is an exploded side view of the attachment mechanism, canoe and cap;

FIG. 12 is a front view of the attachment mechanism of the present invention;

FIG. 13 is a front view of an alternative embodiment of the pouch having a reservoir; and

FIG. 14 is a side view of an alternative embodiment of the pouch having a reservoir.

### DETAILED DESCRIPTION OF THE PREFERRED EMBODIMENTS

The preferred embodiment of the present invention includes a flexible pouch having a fitment at the top. The fitment includes a canoe portion to which the panels of the pouch are affixed. The fitment includes a spout with a channel which extends vertically through the canoe portion and connects to a tube portion of the metering pump. A cap is mounted by a living hinge on top of the canoe portion. The metering pump is suspended from the bottom of the canoe portion to draw the contents of the pouch into the spout and through the channel and out through the cap portion.

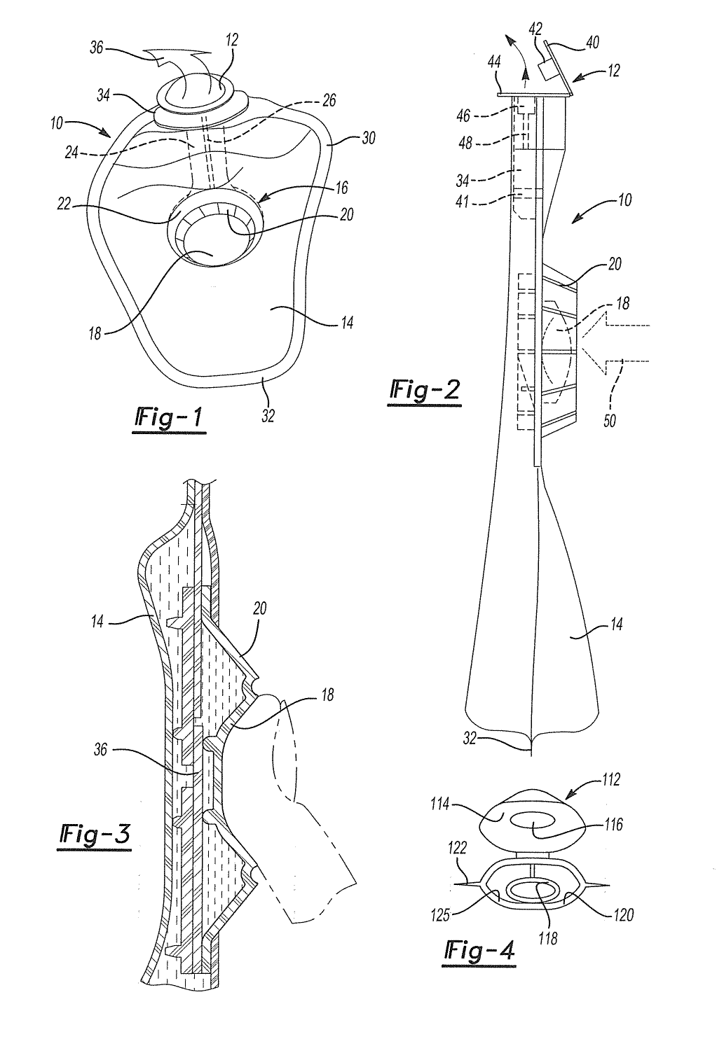

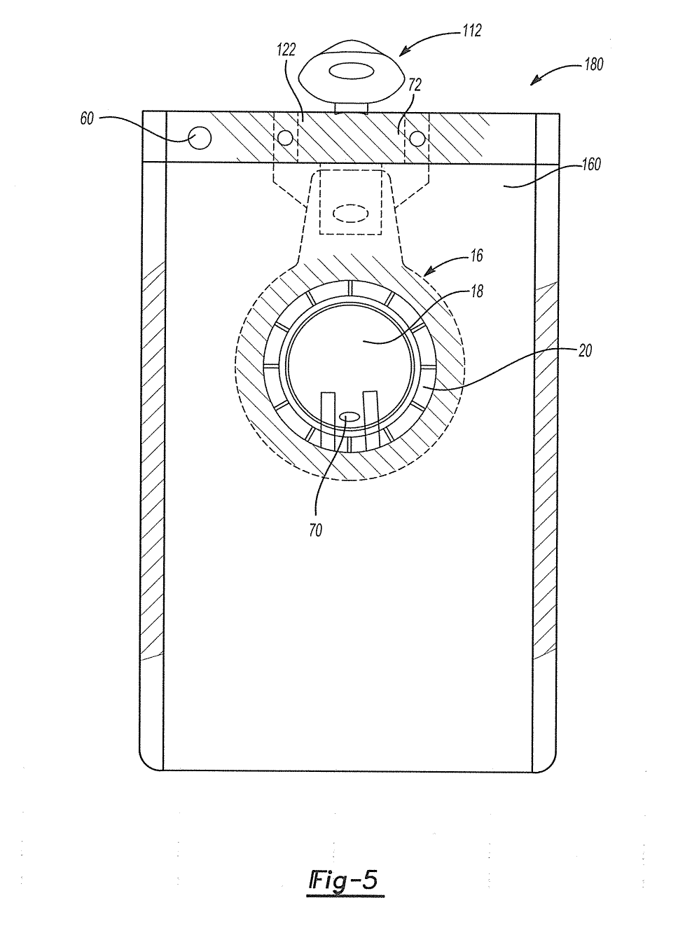

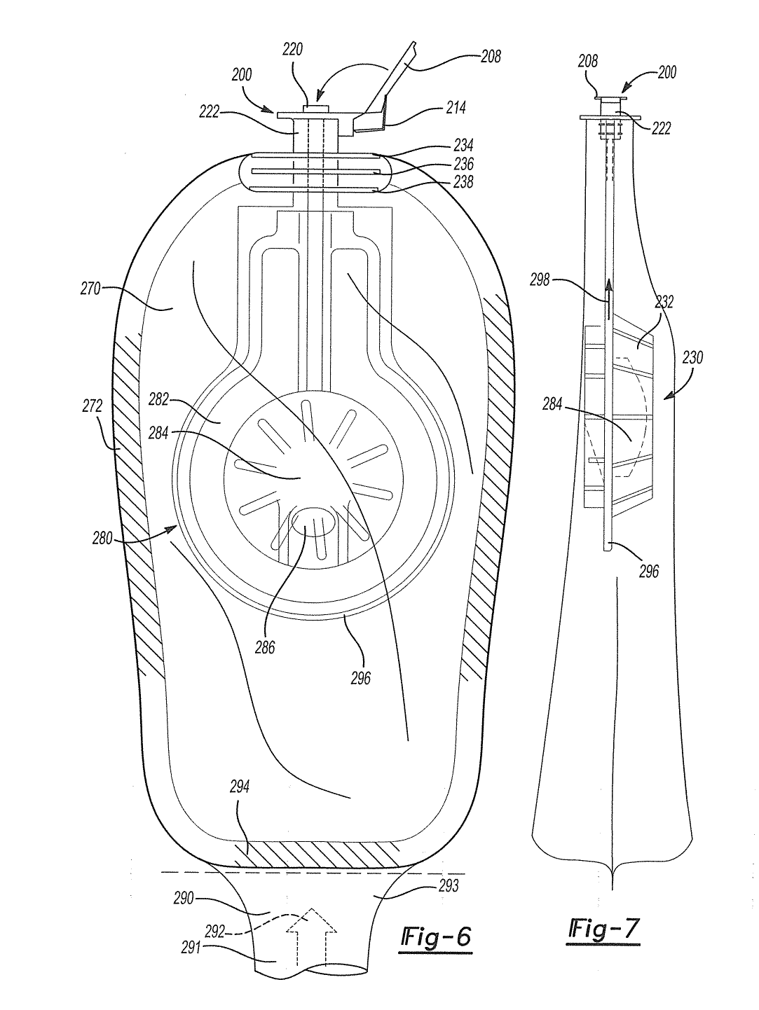

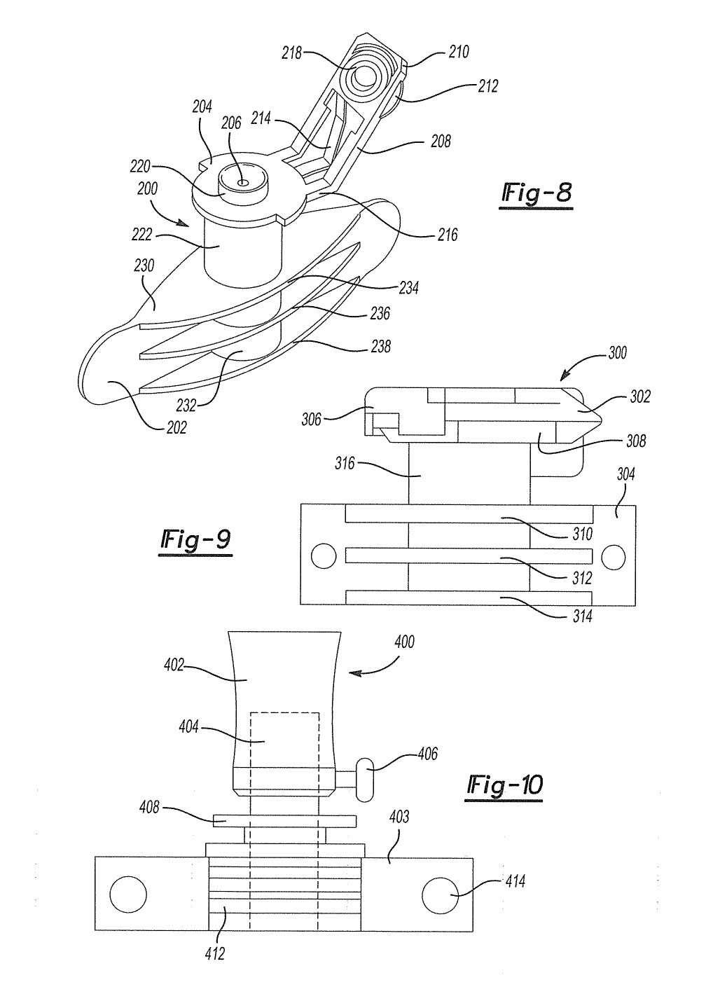

FIG. 1 illustrates a first embodiment of the assembly having the pump portion on a partially exterior portion of the pouch. A second embodiment of the pouch is also illustrated in FIG. 5. A third and preferred embodiment is illustrated in FIGS. 6-8.

A fitment for dispensing fluid from a flexible pouch is provided where the fitment includes a pump and a canoe portion having a passage in fluid communication with the pump, the canoe portion having side walls mounted to the flexible pouch whereby activation of the pump draws fluid from the pouch and through the passage to dispense the fluid.

In reference again to FIG. 1, an assembly 10 having a cap portion 12 and a flexible pouch 14 is disclosed. The assembly 10 further includes a metered dispensing pump 16. The pump includes a dome shaped press button 18 and side walls 20, 22. A first embodiment of a pump capable of being used in all embodiments will now be described. The pump includes a lower portion below the canoe of the fitment which has an orifice to receive fluid from the pump into a large cavity in the lower portion which tapers to a narrow channel which extends through the canoe of the fitment. In an alternative embodiment (such as shown in FIG. 6), the dome portion draws and holds the predetermined amount of fluid. A passageway connects the dome to the outlet of the pump directly in one straight passageway. When the user presses the dome a second time, the predetermined amount of liquid is dispensed.

A base plate for the pump extends downwardly on the side of a lower portion of the pump. The base plate may be molded integrally with the fitment or heat welded to the fitment. The pump has a top portion secured to the base plate. The top portion has a ring surrounding a dome which extends over a one-way flapper valve. A passage extends from the dome along the base plate to the spout orifice. When the dome is depressed, air or fluid is expelled from the cavity under the dome and on its release fluid from the pouch is drawn into the cavity through the flapper valve and forced through the passage of the orifice and into the spout upon a second depression of the pump.

Accordingly, now in reference to FIG. 1, when the dome 18 of the pump 16 is depressed, air is expelled from the pump portion. When the dome is released, fluid from the interior of the pouch is drawn into the holding portion of the pump. Upon a second depression of the dome 18 of the pump 16, fluid is moved out through the orifice or opening of the fitment and cap 12. This movement is illustrated by directional arrow 36.

The pouch 14 is formed by joining two panels at an outer seam (to form a sleeve). The outer edges of the panels are heat welded or otherwise connected to form a pouch-like configuration.

FIG. 2 shows a side view of the pouch as illustrated in FIG. 1. The pouch assembly 10 includes a fitment 12 having a cap 40 with a connector 42. A base plate 44 is operable to receive the connector 42 of the cap portion 40. This cap allows the user to reseal the pouch after use. The fitment 12 includes an orifice 46 in fluid communication with the contents of the pouch 14. A channel 48 connects the holding tank 34 to the outlet of the fitment. Fluid from the pouch 14 travels between the plates of the pump and through the orifice 41 into the holding tank 34. This predetermined amount contained within the holding tank 34 may then be ejected through the fitment 12.

FIGS. 4 and 5 illustrate a secondary embodiment having an alternative resealable cap. The cap or fitment 112 includes a cap portion 114 including a sealing protrusion 116. The sealing protrusion 116 connects with the aperture 118 operable to eject fluid from the pouch. A canoe portion 122 allows the fitment 112 to connect to the pouch 160. The canoe 122 is sealed between two layers or panels forming the pouch 160. This heat treatment is illustrated at 72.

The pouch of the assembly 180 may also include a hang hole 60 allowing the pouch to hang from a display stand. The pump configuration of the assembly 180 is similar or identical to the pump configuration as illustrated in FIGS. 1-3. As illustrated by the figures, the cap of the various embodiments may be several different options. FIG. 2 illustrates a cap having a flat top and a living hinge. FIG. 4 illustrates a fitment where the bottom of the cap is generally dome shaped having a living hinge between the top of the canoe body so that the cap folds down over the channel to close the package or the pouch. A lip may be formed on the cap which snaps into a recess 125 formed on the top of the dome to hold the cap in place.

A flip-top cap, such as those illustrated in FIGS. 2, 5, 6, 7, 8, and 9 includes a cap which has a living hinge at the bottom of the skirt which encircles the spout portion of the pump. The cap in these embodiments snaps down against the spout and may have a cylindrical portion at the bottom side which is received by the canoe body above the channel of the spout. FIG. 9 illustrates an embodiment of the flip cap design having a lid 302 and a canoe portion 304. A cylindrical portion 316 extends between the lid portion and the canoe portion 304. The hinge 306 is provided to allow the lid 304 to pivot about and away from the base portion 308. The canoe portion 304 includes ridges 310, 312, 314 allowing the pouch to better seal to the canoe portion when the ridges 310, 312, 314 melt to the pouch.

FIG. 10 illustrates yet another embodiment for the fitment. FIG. 10 illustrates a tear-off fitment 400 including a sleeve of flexible material 402 connected to an outlet 404 fluidly connected to the pouch. A canoe portion 403 is also provided to connect directly to the pouch. The top of the sleeve is flattened and sealed together with a seal bar. Perforations around the bottom circular portion allow separation of the upper portion from the sleeve from the fitment to provide access to the contents. Further, a tearing member 406 may also be provided to allow access. A connector portion 408 is provided between the sleeve 402 and the canoe portion 403. Various ridges and connection portions 412, 414 are provided on the canoe 403. May also use a roller or tamper evident cap over the spout.

The fitment 200 and pouch assembly of FIGS. 6-8 is the preferred embodiment of the present invention. The fitment 200 includes a canoe portion 202 and a cap portion 204. The cap portion 204 includes a generally planar base plate having an orifice or outlet 206. The cap portion further includes a lid 208 having a lip portion 210 allowing the user to easily pry open the lid 208. Further, various small handle portions 212 are provided on either side of the lid to provide further leverage to the user upon opening of the lid. A living hinge 214 connects the base plate of the cap portion to the lid 208. The living hinge 214 allows the cap to stay in an open configuration while the product is in use. The living hinge further allows the user to snap the lid into place upon closing. Various supports 216 are provided on either side of the living hinge operable to connect the base plate of the cap portion to the lid 208.

The canoe portion 202 is connected to the cap portion by means of a cylindrical portion 222. The cylindrical portion 222 allows liquid or fluid from the interior of the pouch to travel out through the orifice 206. The cylindrical portion 222 further connects the cap portion to the canoe portion 202.

The canoe portion 202 includes a main support 232 and a plurality of horizontally extending ridges 234, 236, 238. During assembly, two panels of the pouch are heat sealed over the canoe portion 202. During this heat sealing process, the ridges 234, 236, 238 melt to further secure and seal the canoe portion 202 and overall fitment 200 to the pouch. The cylindrical portion 222 extends out and away from the pouch. A spout portion is provided extending from the metering pump into the canoe. The canoe is overmolded over the spout of the metering pump.

As illustrated in FIG. 6, a metering pump 280 is provided within the interior of the pouch 270. In alternative embodiments, the pump may be partially on the exterior of the pouch or even extend away from the pouch. The pump 280 includes generally circular side ports 282 and a dome 284. An aperture 286 is provided in the interior of the pump to receive fluid from the interior of the pouch 270. Once the user presses the dome 284 to remove any air within the interior of the pump, the user then releases the dome to draw fluid from the interior of the pouch 270 through the orifice and flap valve 286 to the interior of the pump and within the dome 284. Fluid may also be positioned between two plates 296 of the pump. This predetermined amount is then ejected through the pump upon a second depression of the dome 284. The contents within the pump are of a predetermined amount.

A fitment for sealing a flexible pouch including a canoe portion, the canoe portion connected to a metering pump, the canoe portion molded over a tube portion of the metering pump, the canoe portion sealed to the flexible pouch. A cap is provided connected to the canoe portion, the cap having an outlet, the cap in fluid communication with the metering pump, the cap having a resealable configuration. The canoe portion may include a plurality of ridges operable to melt during sealing of the pouch. These ridges may be arranges in many fashions including, but not limited to wherein the ridges are horizontally extending. The ridges are spaced apart on opposed lateral surfaces. The cap is resealable by means of a lid connected to the cap by means of a living hinge.

The flexible pouch further includes an indicator operable to instruct the user how to operate the flexible pouch. This indicator may be a button which says “press here” or similar language. This indicator will allow the user to more easily and efficiently operate the pump and pouch. Optionally, the pouch is made from a clear or transparent material allowing the user to view the pump. Instructions may also be provided to indicate to the user how to operate the metering pump.

A flexible pouch assembly for dispensing a liquid having a flexible pouch, the flexible pouch having an upper opening. A fitment connected to the opening of the flexible pouch, the fitment having a canoe portion, the canoe portion connected to a metering pump, the canoe portion molded over a tube portion of the metering pump, the canoe portion sealed to the flexible pouch. A cap connected to the canoe portion, the cap having an outlet, the cap in fluid communication with the metering pump, the cap having a resealable configuration. The canoe portion includes a plurality of ridges operable to melt during sealing of the pouch. The ridges are horizontally extending. The ridges are spaced apart on opposed lateral surfaces. The cap is resealable by means of a lid connected to the cap by means of a living hinge. The flexible pouch may include an indicator operable to instruct the user how to operate the flexible pouch.

The pouch is formed generally of a sleeve or a plurality of panels heat sealed 272 together. It is further appreciated that the pouch 270 may be filled upside down through the bottom of the pouch. As illustrated in FIG. 6, before heat sealing the pouch, the bottom of the pouch includes a tail-like portion of the panels. This tail is generally bottle shaped and allows the pouch to be filled in an upside-down configuration. This tail allows fluid to enter through an opening 291 and to be channeled into the interior of the pouch 272. This is illustrated by directional arrow 292. The tail 293 includes the opening 291 which widens gradually as illustrated at 290 to facilitate the flow of liquid. After filling, a seal 294 is created by a heat seal and the tail 293 is cut off from the assembly.

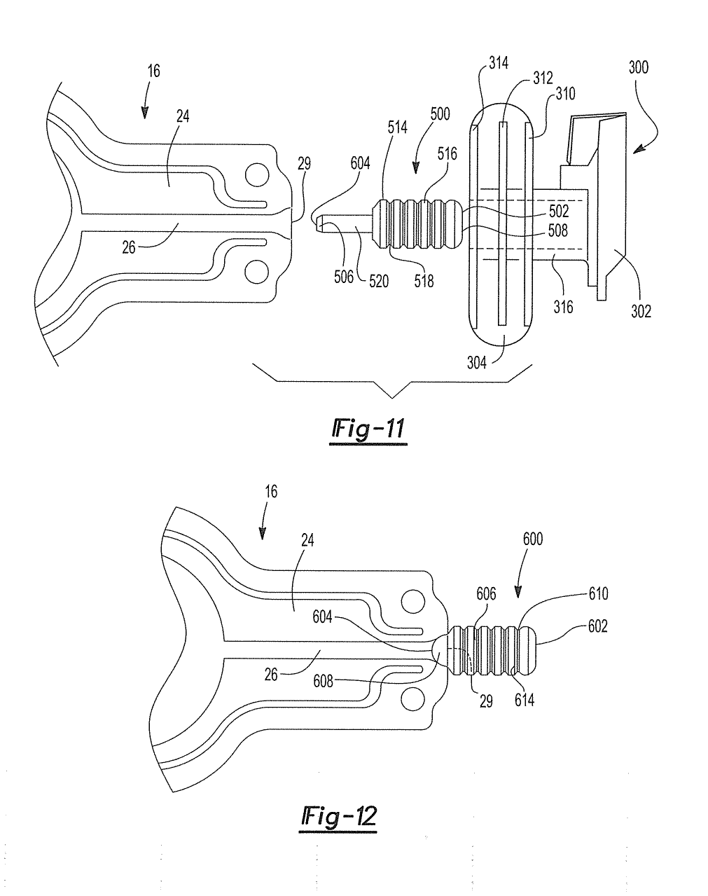

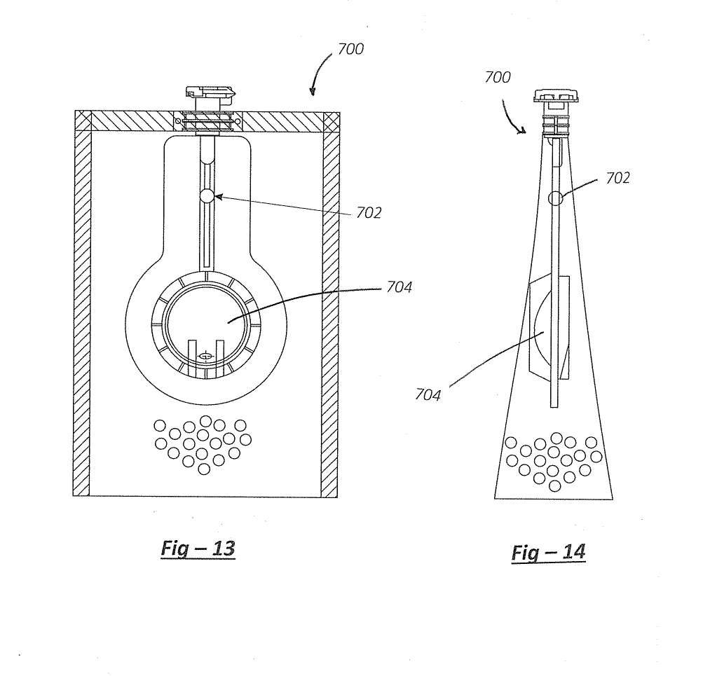

FIGS. 11 and 12 illustrate an embodiment of the present assembly where the outlet includes a first surface having a plurality of ridges. FIG. 11 illustrates an exploded view of the assembly having the pouch 14 having a metering pump. The metering pump includes a channel 26. The channel includes a first end 26 wherein a connector 600 (500) is attached. The connector 600 man be auxiliary from the channel 26 (such as shown in FIG. 11) or permanently attached (molded) to the channel 26 and the metering pump (such as shown in FIG. 12).

FIG. 11 illustrates a connector 500 being auxiliary from the metering pump. The connector 500 includes a first surface 514 having a plurality of ridges 516 and a plurality of valleys 518. The ridges are adapted to melt upon the application of heat to the first surface 514 or through the canoe 304. The ridges 516 are adapted to melt (or partially melt) within the canoe to improve the connection between the connector 500 and the canoe 304. The connector 500 further includes an outlet 503 and an inlet 504. A sloped portion 506 is provided at the inlet 504 to facilitate insertion of the inlet 50 into the outlet 29 of the metering pump. The connector 500 includes an insertion portion 520 allowing for insertion of connector into the channel 29. In the present embodiment, the channel 29 is generally cylindrical. The ridges 516 also permit the installation of a number of different caps having slightly different dimensions. The ridges 516 are operable to make any pouch fit any cap—the ridges 516 provide for universal attachment of a number of different configurations of both caps and pouches to be fitted together.

FIG. 12 illustrates a connector 600 permanently fixed to the metering pump. The connector 600 is molded to the pump. The connector 600 includes an outer surface 606 having a plurality of ridges 614 and valleys 610. The connector 600 further includes an outlet 602 allowing a fluid to flow therethrough. The connector 600 is connected to the metering pump at 608. The connector further includes an inlet 604 operable to accept fluid from the metering pump to allow it to move through the connector. The connectors 500, 600 include a passageway through the center allowing fluid to move therethrough.

In the present embodiment, the canoe and pump are a once piece configuration. The canoe is overmolded over the spout of the pump.

A method of filling the flexible pouch of the present invention includes the steps of forming a flexible pouch having in upper opening and a lower opening, sealing a fitment into the upper opening of the flexible pouch, forming a bottleneck configuration at the lower opening of the flexible pouch, turning the flexible pouch in an upside-down configuration, filling the flexible pouch through the bottleneck of the lower opening of the flexible pouch, sealing the lower opening of the flexible pouch and removing the remaining material of the bottleneck. The method of filling a flexible further includes the step of sealing the fitments to the upper opening of the flexible pouch by means of heat sealing. The method of filling a flexible pouch further including the step of sealing the lower opening of the flexible pouch by means of heat sealing. This sealing process may also be performed by ultra-sonic means such as ultra-sonic welding or sealing. The method of filling a flexible pouch further including the step of removing the remaining material of the bottleneck by cutting the remaining material to form a standard pouch shape. The method of filling a flexible pouch further comprising the step of overmolding a canoe portion over a spout of a metering pump.

An additional embodiment is shown in the pouch assembly 700 further includes a metered dispensing pump 704. The assembly 700 includes a reservoir 702. The pump includes a dome shaped press button and side walls. A first embodiment of a pump capable of being used in all embodiments will now be described. The pump 704 includes a lower portion below the canoe of the fitment which has an orifice to receive fluid from the pump into a large cavity in the lower portion which tapers to a narrow channel which extends through the canoe of the fitment. In the present embodiment the dome portion draws and holds the predetermined amount of fluid. The pimp directs the predetermined amount of fluid towards to reservoir 702 until it is ready to be dispensed. The assembly 700 allows for a specific size reservoir to be included in the pump. This allows for controlled dispensing of specified amounts of product, e.g. 1 ml, 2 ml 5 ml and so forth. The reservoir 702 can be designed to handle the various different size requirements. The pump 704 is depressed once to fill the reservoir with the specified amount of product. The pump 704 is depressed again to release the product in the reservoir 702 and to fill the reservoir 702 with the next shot.

A passageway connects the dome to the outlet of the pump directly in one straight passageway. When the user presses the dome a second time, the predetermined amount of liquid is dispensed. The reservoir 702 is adapted to hold a predetermined amount of fluid for dispersal to the user

The invention is not restricted to the illustrative examples and embodiments described above. The embodiments are not intended as limitations on the scope of the invention. Methods, apparatus, compositions, and the like described herein are exemplary and not intended as limitations on the scope of the invention. Changes therein and other uses will occur to those skilled in the art. The scope of the invention is defined by the scope of the appended claims.

1. A assembly for a flexible pouch, the assembly comprising:
a metering pump, the metering pump having an outlet;
a connector, the connector having a first end and a second end, the first end adapted to connect to the outlet of the metering pump, the second end of the connector adapted to connect to a canoe portion of a fitment, the connector having a first outer surface; and
a plurality of ridges provided on the first outer surface of the connector, the plurality of ridges adapted to facilitate the connection between the canoe and the connector.

2. The assembly of claim 1 wherein the plurality of ridges are operable to melt during heating of the assembly after installation to facilitate the connection between the connector and the canoe.

3. The assembly of claim 1 wherein the canoe portion includes an inner surface having a plurality of ridges, the plurality of ridge of the inner surface of the canoe portion operable to melt during sealing of the pouch.

4. The assembly of claim 1 wherein the ridges are wrap around the connector portion.

5. The assembly of claim 1 wherein the canoe portion is further connected to a cap.

6. The assembly of claim 5 wherein the cap is resealable by means of a lid connected to the cap by means of a living hinge.

7. The assembly of claim 5 wherein the cap is resealable by means of a roller.

8. The assembly of claim 5 wherein the cap is resealable by means of or tamper evident cap.

9. The assembly of claim 1 wherein the flexible pouch includes an indicator operable to instruct the user how to operate the flexible pouch.

10. The assembly of claim 1 wherein the canoe and pump are a once piece configuration.

11. The assembly of claim 1 wherein the connector is fixed to the pump.

12. The assembly of claim 1 wherein the connector is auxiliary from the pump.

13. The assembly of claim 12 wherein the connector includes an insertion portion adapted to be inserted into the pump.

14. The assembly of claim 13 wherein the insertion portion is smaller in diameter as compared to the connector.

15. A fitment for dispensing fluid from a flexible pouch, the fitment comprising:
a pump;
a connector, the connector adapted to connect the pump to a canoe portion, the canoe portion having a passage in fluid communication with the pump, the canoe portion having side walls mounted to the flexible pouch whereby activation of the pump draws fluid from the pouch and through the passage to dispense the fluid.

16. The assembly of claim 15 wherein the canoe portion includes a plurality of ridges operable to melt during sealing of the pouch.

17. The assembly of claim 15 wherein the connector has an outer surface, the outer surface having a plurality of ridges.

18. The assembly of claim 10 wherein a cap is provided connected to the canoe portion, the cap is resealable by means of a lid connected to the cap by means of a living hinge.

19. The assembly of claim 15 wherein the canoe portion is heat sealed to the flexible pouch.

20. The assembly of claim 15 wherein the reservoir is disposed in fluid communication with the pump, the reservoir adapted to hold a predetermined amount of fluid for dispersal to the user.
